(19) United States
(12) Patent Application Publication
(10) Pub. No.: US 2013/0313066 A1
(43) Pub. Date: Nov. 28, 2013

(54) VEHICLE PARKING LOCK DEVICE

(71) Applicants: Yuta Takahashi, Toyota-shi (JP); Hiroki Morita, Toyota-shi (JP); Takuya Kodama, Toyota-shi (JP)

(72) Inventors: Yuta Takahashi, Toyota-shi (JP); Hiroki Morita, Toyota-shi (JP); Takuya Kodama, Toyota-shi (JP)

(73) Assignee: TOYOTA JIDOSHA KABUSHIKI KAISHA, Toyota-shi, Aichi (JP)

(21) Appl. No.: 13/984,433

(22) PCT Filed: Feb. 15, 2011
(86) PCT No.: PCT/JP2011/053077

§ 371 Date: Aug. 8, 2013

(51) Int. Cl. F16H 63/34

(52) U.S. Cl. CPC F16H 63/3416
USPC 192/220.2

(57) ABSTRACT

A vehicle parking lock device stopping rotation of a parking gear formed on a rotating member coupled to drive wheels to stop rotation thereof, including: a parking pole having a claw portion for engagement with the parking gear, the parking pole being rotatable around a support shaft by pushing out a cam movable in an axial direction of the parking gear, the support shaft being in parallel with the axial direction; a stopper plate contacting the parking pole to regulate movement in the axial direction; and a spring contacting the parking pole to bias it in a direction of release of engagement between the claw portion and parking gear, the vehicle parking lock device being configured to dispose a contact point of the contact between the spring and parking pole closer to the stopper plate in the axial direction than a contact point between the parking pole and cam.

### TECHNICAL FIELD

The present invention relates to a parking lock device included in a vehicle and particularly to a technique of stabilizing posture of a parking pole making up the parking lock device.

### BACKGROUND ART

A vehicle parking lock device is well known that stops rotation of a parking gear formed on a rotating member coupled to drive wheels so as to stop rotation of the drive wheels. For example, a parking lock device described in Patent Document 1 is an example thereof. In Patent Document 1, a pawl 9 formed on a lock piece 7 engages with a lock gear 6, thereby fixing an output shaft 4 in a non-rotatable manner.

### PRIOR ART DOCUMENT

### Patent Document

Patent Document 1: Japanese Laid-Open Patent Publication No. 2001-328514

### SUMMARY OF THE INVENTION

### Problem to Be Solved by the Invention

A vehicle parking lock device 200 as depicted in FIG. 10 has also been realized. In FIG. 10, the vehicle parking lock device 200 includes a parking gear 202 rotated around an axial center O1, a parking pole 206 having a claw portion 204 for engagement with the parking gear 202 and supported rotatably around an axial center O2 so that the claw portion 204 can engage with and disengage from the parking gear 202, a cam 208 pushed out in parallel with an axial direction of the parking gear 202 to rotate the parking pole 206 in accordance with a movement amount thereof, a stopper plate 210 contacting the parking pole 206 to regulate movement of the parking pole 206 in the axial direction, and a spring 212 contacting the parking pole 206 to apply a biasing force rotating the parking pole 206 toward the side causing release of engagement between the claw portion 204 of the parking pole 206 and the parking gear 204.

FIG. 10 depicts a state in which the claw portion 204 of the parking pole 206 engages with the parking gear 202. Specifically, when the cam 208 movable in the axial direction of the parking gear 202 moves toward the near side in FIG. 10, a contact point varies between a taper portion not depicted formed on the leading end of the cam 208 and the parking pole 206, and the parking pole 206 is rotated counterclockwise around the axial center O2 against the biasing force of the spring 212. In this case, the claw portion 204 of the parking pole 206 is engaged with the parking gear 202, thereby stopping the rotation of the parking gear 202.

On the other hand, although not depicted, when the cam 208 moves toward the far side in FIG. 10, the biasing force of the spring 212 rotates the parking pole 206 clockwise around the axial center O2. In this case, the engagement is released between the claw portion 204 and the parking gear 202.

FIG. 11 is a simplified cross-sectional view taken along A-A when the parking pole 206, the spring 212, and the cam 208 of FIG. 10 are cut along a cutting line A. In FIG. 11, when the cam 208 moves, the contact point varies between a taper portion 214 formed on the leading end of the cam 208 and the parking pole 206, and the parking pole 206 is rotated around the axial center O2. Specifically, when the cam 208 moves to the left in FIG. 11, the parking pole 206 comes into contact with a rear end portion of the taper portion 214 of the cam 208 and the parking pole 206 is rotated counterclockwise (upward in FIG. 11). FIG. 11 depicts a state in which the parking pole 206 is rotated counterclockwise. On the other hand, when the cam 208 moves to the right in FIG. 11, the parking pole 206 comes into contact with a leading end portion of the taper portion 214 and the parking pole 206 is rotated clockwise (downward in FIG. 11).

As depicted in FIG. 11, after the cam 208 moves to the left in FIG. 11, i.e., in the engaged state between the claw portion 204 of the parking pole 206 and the parking gear 202 depicted in FIG. 10, the parking pole 206 is subjected to the action of the moment M2 due to a cam reaction force F2 acting on a contact point X2 and the moment M1 due to a biasing force F1 of the spring 212 acting on a contact point X1. The cam reaction force F2 is generated at a point of contact between the parking pole 206 and the stopper plate 210 in FIG. 10 (corresponding to 210a of FIG. 10) and acts in the direction opposite to the direction of the cam 208 pressing the parking pole 206. As depicted in FIG. 11, the moment M1 acts clockwise and the moment M2 also acts clockwise relative to a contact point X0 between the parking pole 206 and the cam 208.

As described above, the moment M1 due to the biasing force F1 of the spring 212 acts in the clockwise direction because the spring 212 contacts an edge of the parking pole 206. Specifically, while the claw portion 204 of the parking pole 206 and the parking gear 202 are disengaged, as depicted in FIG. 12, the spring 212 and the parking pole 206 are in surface-contact. On the other hand, while the claw portion 204 and the parking gear 202 are engaged, as depicted in FIG. 13, the spring 212 contacts an edge 216 of the parking pole 206. As a result, the moment M1 acts clockwise by using the contact point X0 between the parking pole 206 and the cam 208 as a fulcrum. Therefore, the parking pole 206 is subjected to the action of the moment M2 due to the cam reaction force F2 and the moment M1 due to the biasing force F1 of the spring 212 in the same direction, and the parking pole 206 is tilted. If the parking pole 206 is tilted in this way, the claw portion 204 of the parking pole 206 is brought into partial contact with the parking gear 202 and, therefore, surface pressure and stress locally increase in an engagement portion between the claw portion 204 and the parking gear 202, resulting in a possible increase in abrasion of the claw portion 204 and the parking gear 202.

The present invention was conceived in view of the situations and it is therefore an object of the present invention to provide a vehicle parking lock device capable of suppressing a tilt of a parking pole making up the vehicle parking lock device.

### Means for Solving the Problem

To achieve the object, the first aspect of the invention provides (a) a vehicle parking lock device stopping rotation of a parking gear formed on a rotating member coupled to drive wheels to stop rotation of the drive wheels, comprising: a parking pole having a claw portion for engagement with the parking gear, the parking pole being allowed to rotate around a support shaft by pushing out a cam movable in an axial direction of the parking gear, the support shaft being in parallel with the axial direction; a stopper plate contacting the parking pole to regulate movement of the parking pole in the axial direction; and a spring contacting the parking pole to bias the parking pole in a direction of release of engagement between the claw portion of the parking pole and the parking gear, wherein (b) a contact point of the contact between the spring and the parking pole is disposed closer to the stopper plate in the axial direction than a contact point between the parking pole and the cam.

### Effects of the Invention

Consequently, since the contact point between the parking pole and the spring is changed to a point closer to the stopper plate in the axial direction than the contact point between the parking pole and the cam, the moment generated by the biasing force of the spring acts in the direction opposite to the moment generated by the cam reaction force. Therefore, the moment generated by the cam reaction force and the moment generated by the biasing force of the spring are cancelled by each other and the tilt of the parking pole is suppressed.

Preferably, the cutout for preventing contact between the parking pole and the spring is formed on the side opposite to the parking plate in the axial direction of the parking pole. As a result, the contact point can be moved toward the parking plate in the axial direction of the parking pole and the contact point can be changed to a point closer to the stopper plate in the axial direction than the contact point between the parking pole and the cam.

Preferably, (a) the parking pole has the spring insertion hole formed for inserting the spring and the spring is inserted into the spring insertion hole to be in contact with the parking pole, and (b) a diameter of the hole is formed larger on the side opposite to the parking plate side in the axial direction of the spring insertion hole than a diameter on the parking plate side in the axial direction so as to prevent the parking pole from contacting the coil spring. As a result, since the spring can be brought into contact on the stopper plate side in the axial direction of the parking pole, the contact point can be changed to a point closer to the stopper plate in the axial direction than the contact point between the parking pole and the cam.

Preferably, the spring is formed such that the contact point between the spring and the parking pole is located closer to the stopper plate in the axial direction than the contact point between the parking pole and the cam. Consequently, the contact point can be changed to a point closer to the stopper plate in the axial direction than the contact point between the parking pole and the cam.

### BRIEF DESCRIPTION OF THE DRAWINGS

FIG. 1 is a schematic for explaining a configuration of a vehicle power transmission device of an example of the present invention.

FIG. 2 is a partial cross-sectional view when the vehicle power transmission device is cut along a cross-section taken along B-B in FIG. 1, depicting a main portion of the vehicle parking lock device.

FIG. 3 is a simplified view of a cross-section taken along C-C when the parking pole, the spring, and the cam are cut along a cutting line C in the parking lock device of FIG. 2.

FIG. 4 is a perspective view for explaining a shape of the parking pole of FIG. 2.

FIG. 5 is the other mode indicating the parking pole, the spring, and the cam in the parking lock device of FIG. 2 and corresponds to FIG. 3.

FIG. 6 is a diagram for depicting an experimental result of experimental measurement of a tilt amount (mm) of the parking pole during ratcheting.

FIG. 7 is a perspective view of a parking pole making up a vehicle parking lock device that is another example of the present invention.

FIG. 8 is a cross-sectional view taken along E-E when the parking pole of FIG. 7 is cut along a cutting line E.

FIG. 9 is a diagram for explaining a configuration of the parking pole, the coil spring and the cam making up a vehicle parking lock device that is another example of the preset invention and corresponds to FIG. 3 of the example.

FIG. 10 is a diagram for explaining a conventional vehicle parking lock device.

FIG. 11 is a cross-sectional view taken along A-A indicating a state simply when the parking pole, the spring, and the cam are cut along a cutting line A in the vehicle parking lock device of FIG. 10.

FIG. 12 is a diagram for depicting a contact state between the parking pole and the spring of FIG. 11.

FIG. 13 is another diagram for depicting a contact state between the parking pole and the spring of FIG. 11.

### MODES FOR CARRYING OUT THE INVENTION

Examples of the present invention will now be described in detail with reference to the drawings. In the following examples, the figures are simplified or deformed as needed and portions are not necessarily precisely depicted in terms of dimension ratio, shape, etc.

### First Example

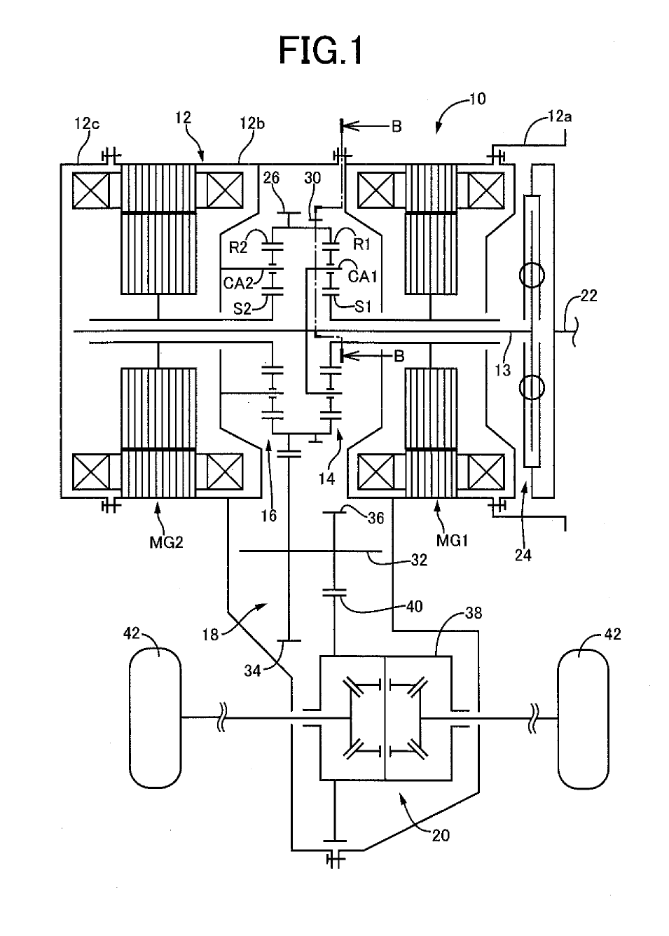

FIG. 1 is a schematic for explaining a configuration of a vehicle power transmission device 10 (hereinafter, the power transmission device 10) of an example of the present invention. In FIG. 1, the power transmission device 10 is preferably employed in a hybrid vehicle of the FF (front-engine front-drive) type. The power transmission device 10 includes, in a housing 12 formed by assembling a case 12a, a case 12b, and a cover 12c made of die-cast aluminum, for example, a rotatably supported input shaft 13, a first electric motor MG1 and a second electric motor MG2 acting as an electric motor as well as an electric generator, a first planetary gear device 14 and a second planetary gear device 16 of a single pinion type, a reduction gear device 18, and a differential gear device 20.

The input shaft 13 is disposed concentrically with a crankshaft 22 of, for example, an engine not depicted that is a main drive power source for running. The input shaft 13 is coupled to the crankshaft 22 in a power transmittable manner via a damper device 24 for absorbing and damping pulsations due to abrupt torque variations.

The first planetary gear device 14 acts as a power distribution mechanism for mechanically distributing a torque generated by the engine to the first electric motor MG1 and the reduction gear device 18. The first planetary gear device 14 includes a carrier CA1 coupled to the input shaft 13, a sun gear S1 coupled to the first electric motor MG1, and a ring gear R1 fixedly disposed on an inner circumferential surface of a drive gear 26. A parking gear 30 making up a portion of a vehicle parking lock device 28 (hereinafter, the parking lock device 28) of an example of the present invention is fixedly disposed on an outer circumferential surface of an end portion of the drive gear 26 (corresponding to a rotating member of the present invention) closer to the first electric motor MG1.

The second planetary gear device 16 acts as a reduction mechanism of the second electric motor MG2. The second planetary gear device 16 includes a sun gear S2 coupled to the second electric motor MG2, a carrier CA2 coupled to the case 12b, and a ring gear R2 fixedly disposed on the inner circumferential surface of the drive gear 26.

The first electric motor MG1 is mainly used as an electric generator and is rotationally driven via the planetary gear mechanism 14 by the engine to generate electric energy so as to charge, for example, an electric storage device such as a battery with the electric energy. The first electric motor MG1 is used not only as the electric generator but also as an electric motor at the start of the engine and during high-speed running, for example.

The second electric motor MG2 is mainly used as an electric motor and rotationally drives the drive gear 26 alone or in conjunction with the engine. The second electric motor MG2 is used not only as the electric motor but also as an electric generator during deceleration of a vehicle, for example.

The reduction gear device 18 is disposed between the drive gear 26 and the differential gear device 20 and acts as a reduction mechanism. The reduction gear device 18 includes the drive gear 26, a driven gear 34 fixedly disposed on a counter shaft 32, which is disposed in parallel with the input shaft 13, to engage with the drive gear 26, a drive gear 36 fixedly disposed on the counter shaft 32, and a driven gear 40 fixedly disposed on a differential case 38 of the differential gear device 20 to engage with the drive gear 36.

The differential gear device 20 is of a well-known bevel gear type and respectively rotationally drives a pair of left and right drive shafts 42 while allowing a rotational difference.

In the transaxle 10 configured as described above, a torque generated by at least one of the engine, the first electric motor MG1, and the second electric motor MG2 is transmitted via the drive gear 26, the reduction gear device 18, and the differential gear device 20 to a pair of the left and right drive wheels 42.

A configuration of the parking lock device 28 will hereinafter be described in detail that non-rotatably fixes the parking lock gear 30 rotated together with the drive gear 26 so as to lock the rotation of the power transmission device 10.

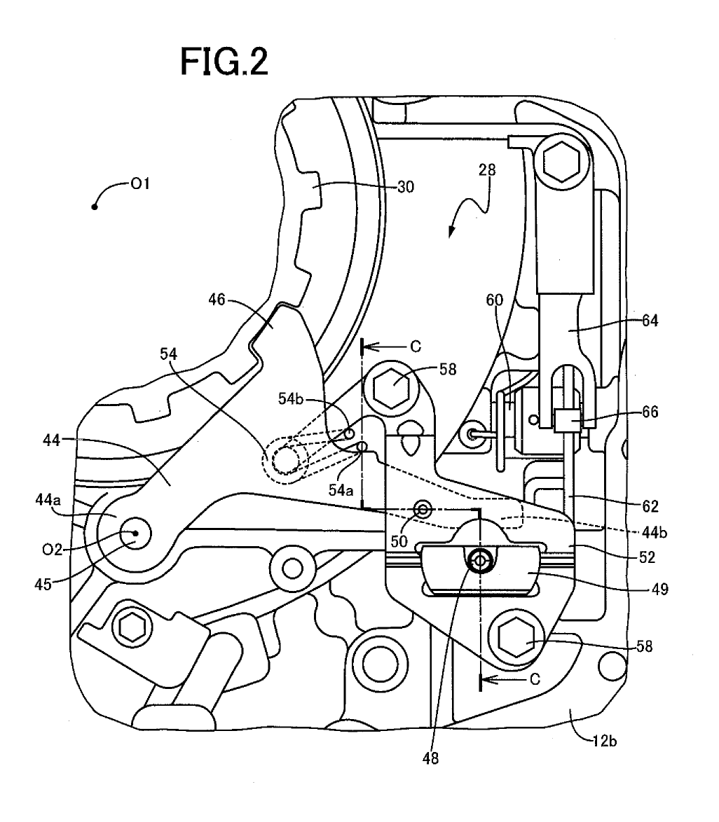

FIG. 2 is a partial cross-sectional view (cross-sectional view taken along B-B) of the power transmission device 10 cut along a cutting line B of FIG. 1, depicting a main portion of the parking lock device 28 in the case 12b viewed from the opening side of the case 12b. In FIG. 2, the parking lock device 28 is disposed to stop the rotation of the parking gear 30 so as to stop the rotation of the drive wheels 42 mechanically coupled to the parking gear 30. The parking lock device 28 includes the parking gear 30 rotated around an axial center O1, a parking pole 44 having a claw portion 46 for engagement with the parking gear 30 and a base end potion 44a supported rotatably around an axial center O2 of a support shaft 45 so that the claw portion 46 can engage with and disengage from the parking gear 30, a cam 48 having an end portion formed into a taper shape and capable of moving in an axial direction parallel to the rotation axis of the parking gear 30 while the end portion is in contact with the other end potion 44b formed on the parking pole 44, a cam sleeve 49 supporting the cam 48, a plate-shaped stopper plate 52 having a projection 50 formed to be in contact with the parking pole 44 so as to regulate movement of the parking pole 44 in the axial direction parallel to the rotation axis of the parking gear 30, and a coil spring 54 (spring of the present invention) contacting the parking pole 44 to bias the parking pole 44 in the direction of release of the engagement between the claw portion 46 of the parking pole 44 and the parking gear 30. Unless specifically mentioned in the following description, the axial direction is defined as a direction parallel to the rotation axis of the parking gear 30.

FIG. 2 depicts a state in which the claw portion 46 of the parking lock pole 44 engages with the parking lock gear 30. The parking lock pole 44 has the base end portion 44a formed into a substantially triangular shape as depicted in FIG. 2 and rotatably supported by the support shaft 45, the other end portion 44b in contact with the cam 48, and a claw portion 46 for engagement with the parking gear 30. The parking pole 44 is rotated between an engaged position to which the claw portion 46 of the parking pole 44 is rotated toward the side closer to the parking lock gear 30 (the counterclockwise side of FIG. 2) such that the claw portion 46 engages with the parking lock gear 30 to non-rotatably fix the parking lock gear 30 and a disengaged position to which the claw portion 46 is rotated toward the side away from the parking lock gear 30 (the clockwise side of FIG. 2) such that the claw portion 46 does not engage with the parking lock gear 30 to allow the rotation of the parking lock gear 30. The parking lock pole 44 is always biased toward the disengaged position by the coil spring 54 and is positioned at the disengaged position while no external force is applied except the biasing force.

The stopper plate 52 is fixed by two bolts 58 to the housing 12 with the parking pole 44 assembled such that the parking pole 44 is sandwiched. The parking pole 44 comes into contact with the projection 50 of the stopper plate 52 and is regulated to be immovable in the axial direction. The projection 50 is formed by press-forming, for example. In FIG. 2, a recess is depicted that is formed by forming the projection 50 projecting toward the parking pole 44 in the axial direction by press-forming. As described above, the parking pole 44 is in contact only with the projection 50, rather than the entire surface of the stopper plate 52.

The coil spring 54 is assembled behind the parking pole 44 in FIG. 2 and the both ends thereof have a first member 54a and a second member 54b formed to extend toward the parking pole 44 in the axial direction. The first member 54a is in contact with a side surface of the parking pole 44 and biases the parking pole 44 in the direction causing clockwise rotation. On the other hand, the second member 54b is in contact with the stopper plate 52 and acts as a member receiving a reaction force from the first member 54a.

The vehicle parking lock device 28 includes a plate-shaped detent plate 62 fixedly disposed on a shift control shaft 60, which rotates depending on a switching operation of a shift position of the power transmission device 10, and rotated to any one of a plurality of preset rotation positions. The detent plate 62 is positioned at any one shifted position of preset parking, reverse, neutral, drive, and manual positions in accordance with a cam surface shape of the outer circumferential end edge thereof and is also referred to as a parking lever or a moderating plate. When the shifted position corresponding to a selected shift position is engaged with an engagement roller 66 attached to a leading end of a plate-shaped spring 64, a power transmission state is switched in accordance with the shifted position.

If the parking position is selected, a parking rod not depicted coupled to the detent plate 62 is moved toward the stopper plate 52 (toward the near side of FIG. 2) in the axial direction. The cam 48 is attached to the end portion of the parking rod. Therefore, if the parking position is selected, the cam 48 is pushed out toward the stopper plate 52 (toward the near side of FIG. 2) in the axial direction. A taper formed on the cam 48 has a diameter made smaller toward the leading end and, as the cam 48 is pushed out toward the stopper plate 52 in the axial direction, the other end portion 44b of the parking pole 44 is pushed upward. Therefore, since the parking pole 44 is rotated counterclockwise around the axial center 02, the claw portion 46 of the parking pole 44 is engaged with the parking gear 30 and the rotation of the parking gear 30 is stopped.

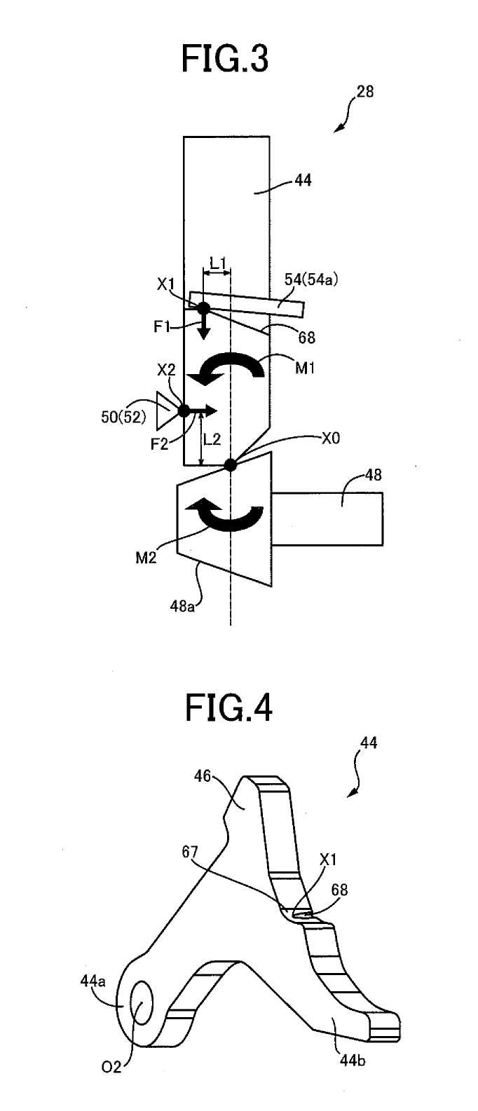

FIG. 3 is a simplified view of a cross-section (cross-section taken along C-C) when the parking pole 44, the coil spring 54 (the first member 54a), and the cam 48 are cut along a cutting line C in the parking lock device 28 of FIG. 2. FIG. 3 depicts a state in which the claw portion 46 of the parking pole 44 is engaged with the parking gear 30. As depicted in FIG. 3, while the cam 48 moves toward the stopper plate 52 (to the left in FIG. 3), the parking pole 44 is rotated counterclockwise (upward in FIG. 3). In this case, the coil spring 54 applies a biasing force Fl in the direction toward the cam 48 (downward in FIG. 3) acting on a contact point X1 between the parking pole 44 and the coil spring 54.

A cutout 68 is formed by chamfering on a contact surface 67 of the parking pole 44 of this example for the coil spring 54. FIG. 4 is a perspective view of the parking pole 44. As depicted in FIG. 4, the cutout 68 is formed on the side opposite to the side of the contact with the projection 50 of the stopper plate 52 in the axial direction of the parking pole 44. In a region with the cutout 68 formed, the coil spring 54 is prevented from contacting the parking pole 44. As a result, the contact point X1 between the parking pole 44 and the coil spring 54 is set closer to the stopper plate 52 in the axial direction than a contact point X0 between the parking pole 44 and a taper portion 48a of the cam 48. Therefore, assuming that L1 is a distance between the contact point X0 and the contact point X1 in the axial direction (a plate thickness direction of the parking pole 44), the parking pole 44 is subjected to the action of the anticlockwise moment M1 (=F1×L1) calculated as the product of the biasing force F1 and the distance L1 based on the contact point X0.

A cam reaction force F2 to the pressing force of the cam 48 acts on a contact point X2 between the projection 50 of the stopper plate 52 and the parking pole 44. Assuming that L2 is a distance perpendicular to the plate thickness of the parking pole 44 between the contact point X2 and the contact point X0, the parking pole 44 is subjected to the action of the clockwise moment M2 (=F2×L2) calculated as the product of the cam reaction force F2 and the distance L2 based on the contact point X0.

As described above, the parking pole 44 is subjected to the action of the anticlockwise moment M1 and the clockwise moment M2, and the moment M1 and the moment M2 act in the directions opposite to each other. Therefore, the moments act to cancel each other and, thus, the moment M (=M2−M1) acting on the parking pole 44 is suppressed. Since the cam reaction force F2 is generally greater than the biasing force F1 of the coil spring 54, the moment M2 becomes greater than the moment M1. As a result, although the moment M acting on the parking pole 44 in FIG. 3 acts in the anticlockwise direction, the moment M is cancelled by the moment M1 to a smaller value and a tilt of the parking pole 44 in the axial direction is reduced.

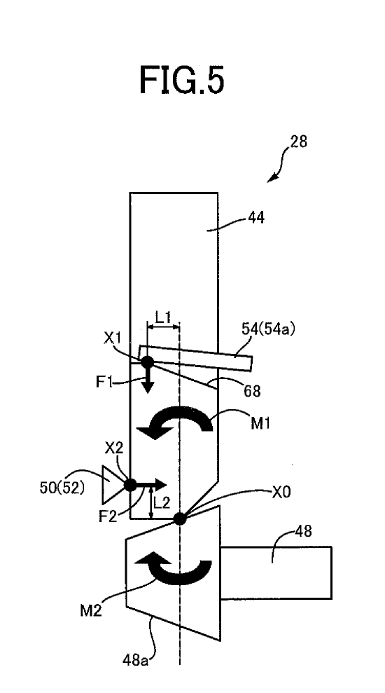

As depicted in FIG. 5, if the distance L1 is configured to be equal to or greater than the distance L2, the moment M (=M2−M1) is further reduced and the tilt of the parking pole 44 is suppressed. More preferably, if the moment M2 and the moment M1 become equal to each other, i.e., if the distance L1 is made longer than the distance L2 to the extent that the moment M is set to zero, the tilt of the parking pole 44 becomes substantially zero.

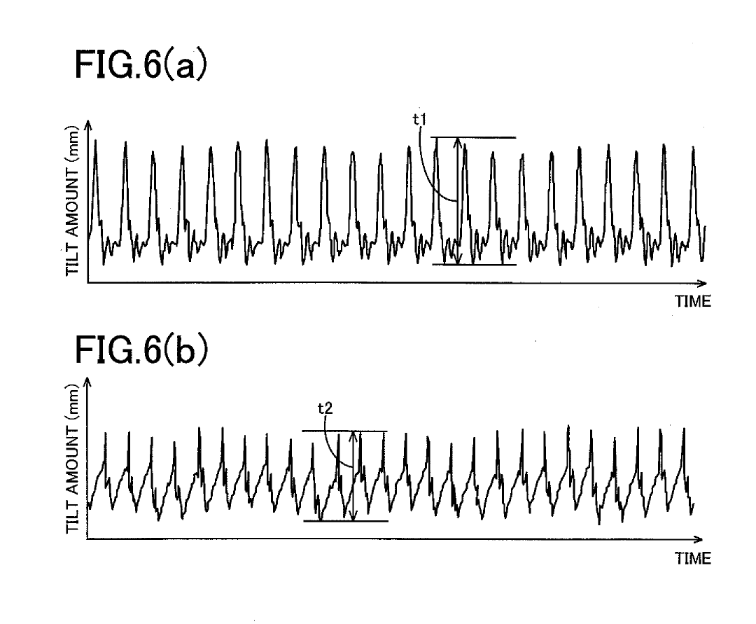

FIG. 6 depicts a result of experimental measurement of a tilt amount (mm) of the parking pole 44. In FIG. 6, (a) indicates a tilt amount t1 when the cutout 68 is not formed and (b) indicates a tilt amount t2 when the cutout 68 of this example is formed. The tilt amounts t1 and t2 are measurement values at the time of collision, i.e., at the time of so-called ratcheting, between the claw portion 46 and the parking gear 30 occurring when the claw portion 46 is gradually engaged with the parking gear 30 by using the disengaged state between the claw portion 46 of the parking pole 44 and the parking gear 30 as a reference position. For the tilt amounts t1 and t2, for example, displacements of three arbitrary points of the parking pole 44 are detected by using a displacement sensor so as to sequentially calculate the tilt amounts t1 and t2 based on a normal vector calculated by using the cross product from the displacements of the three points.

As depicted in FIGS. 6(a) and 6(b), at the time of ratcheting, the tilt amounts t1 and t2 have a local maximum value at intervals. The local maximum value is a value when the claw portion 46 collides with the parking gear 30 and, at the moment of collision of the claw portion 46 with the parking gear 30, the tilt amount is maximized by a reaction force due to the collision. Comparing FIGS. 6(a) and 6(b), it is confirmed in this measurement that the tilt amount is reduced by about 26% in (b) with the cutout 68 formed as compared to (a) without the cutout 68. In other words, it is confirmed that since the formation of the cutout 68 changes the contact point X1 between the coil spring 54 and the parking pole 44 from the edge of the parking pole 44 as in the conventional case to a point closer to the stopper plate 52 than the contact point X0 between the parking pole 44 and the cam 48, the moment M (=M2−M1) causing the parking pole 44 to tilt is suppressed so that the tilt of the parking pole 44 is suppressed.

As described above, according to this example, since the contact point X1 between the parking pole 44 and the coil spring 54 is changed to a point closer to the stopper plate 52 in the axial direction than the contact point X0 between the parking pole 44 and the cam 48, the moment M1 generated by the biasing force F1 of the coil spring 54 acts in the direction opposite to the moment M2 generated by the cam reaction force F2. Therefore, the moment M2 generated by the cam reaction force F2 and the moment M2 generated by the biasing force F1 of the coil spring 54 are cancelled by each other and the tilt of the parking pole 44 is suppressed. As a result, a local increase in surface pressure and stress is suppressed in an engagement portion between the claw portion 46 and the parking gear 30 and, as a result, abrasion of the claw portion 46 and the parking gear 30 can be suppressed.

According to this example, the cutout 68 for preventing contact between the parking pole 44 and the coil spring 54 is formed on the side opposite to the parking plate 52 in the axial direction of the parking pole 44. As a result, the contact point X1 can be moved toward the parking plate 52 in the axial direction of the parking pole 44 and the contact point X1 can be changed to a point closer to the stopper plate 52 in the axial direction than the contact point X2 between the parking pole 44 and the cam 48.

Other examples of the present invention will be described. In the following description, the portions common to the examples will be denoted by the same reference numerals and will not be described.

### Second Example

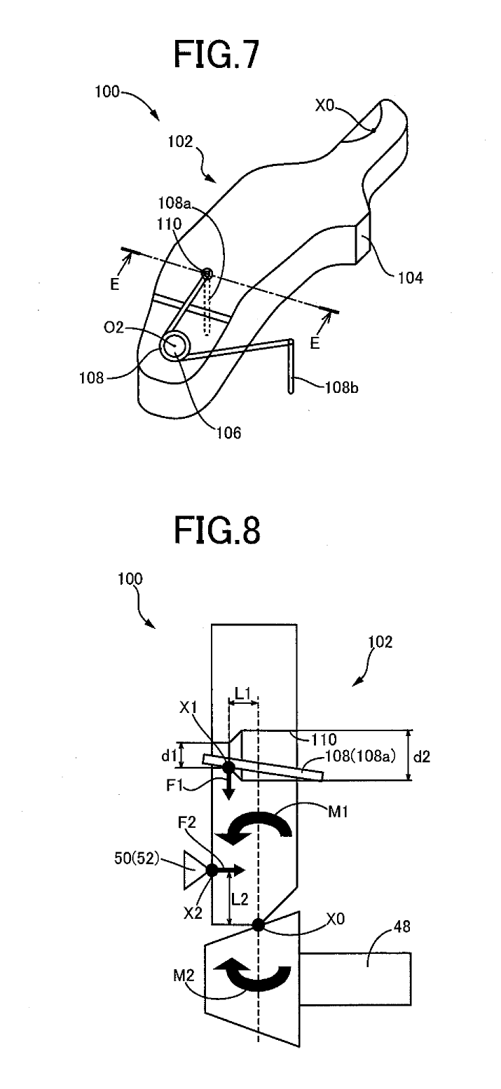

FIG. 7 is a perspective view of a parking pole 102 and a coil spring 108 making up a vehicle parking lock device 100 that is another example of the present invention. The other members making up the parking lock device 100 are substantially the same as the parking lock device 28 of the example and therefore will not be described. The parking pole 102 has a claw portion 104 formed for engagement with the parking gear 30 as is the case with the example. A cam not depicted comes into contact with the contact point X0 of the parking pole 102 and the parking pole 102 is rotated around the axial center O2. In this example, the coil spring 108 is supported by a support shaft 106 supporting the parking pole 102 rotatably around the axial center O2. The both end portions of the coil spring 108 have a first member 108a and a second member 108b formed to extend in parallel with the axial direction of the support shaft 106 and the first member 108a is inserted into a spring insertion hole 110 formed in the parking pole 102. The second member 108b is supported in a state of being in contact with a stop member (case) not depicted. The second member 108b acts as a member receiving a reaction force from the first member 108a.

The first member 108a of the coil spring 108 is inserted into and in contact with the spring insertion hole 110 and the coil spring 108 biases the parking pole 102 at the contact point X1 between the first member 108a and the spring insertion hole 110 in the direction of release of the engagement between the claw portion 104 of the parking pole 102 and the parking gear 30. In other words, the coil spring 108 applies to the parking pole 102 the biasing force F1 acting in the direction of release of the engagement between the claw portion 104 and the parking gear 30.

FIG. 8 is a cross-sectional view taken along E-E when the parking pole 102 of FIG. 7 is cut along a cutting line E. In FIG. 8, the cam 48 is depicted to indicate a state of the moment acting on the parking pole 102. As depicted in FIG. 8, the spring insertion hole 110 is subjected to two-stage machining, and a diameter dl of the hole is formed larger on the side opposite to the projection 50 side (stopper plate 52 side) in the plate thickness direction of the parking pole 102 (corresponding to the axial direction of the parking gear 30) than a diameter d2 of the hole on the projection 50 side. As a result, the contact with the coil spring 108 is prevented on the side opposite to the projection 50 side (stopper plate 52 side) in the plate thickness direction of the parking pole 102. Therefore, the contact point X1 between the coil spring 108 (first member 108a) and the parking pole 102 is set closer to the projection 50 (stopper plate 52) than the contact point X0 between the parking pole 102 and the cam 48 in the plate thickness direction of the parking pole 102. Therefore, in the parking pole 102, the moment M1 (=F1×L1) is generated by the biasing force F1 of the spring 108 acting on the contact point X1 and acts in the anticlockwise direction relative to the contact point X0. The moment M2 (=F2×L2) is generated by the cam reaction force F2 acting on the contact point X2 between the projection 50 (stopper plate 52) and the parking pole 102 and acts in the clockwise direction relative to the contact point X0. As a result, the moment M actin on the parking pole 102 is canceled by the moment M1 and the moment M2 and, therefore, the tilt of the parking pole 102 is suppressed. In other words, even when the parking pole 102 is configured as described above, the same effects as the example are acquired.

As described above, according to this example, the parking pole 102 has the spring insertion hole 110 formed for inserting the coil spring 108 and the coil spring 108 is inserted into the spring insertion hole 110 to be in contact with the parking pole 102, and (b) a diameter of the hole is formed larger on the side opposite to the parking plate 52 side in the axial direction of the spring insertion hole 110 than a diameter on the parking plate 52 side in the axial direction so as to prevent the parking pole 102 from contacting the coil spring 108. As a result, since the coil spring 108 can be brought into contact on the stopper plate 52 side in the axial direction of the parking pole 102, the contact point X1 can be changed to a point closer to the stopper plate 52 in the axial direction than the contact point X0 between the parking pole 102 and the cam 48. Therefore, the configuration described above enables the effect that the tilt of the parking pole 102 can be suppressed as is the case with the example.

### Third Example

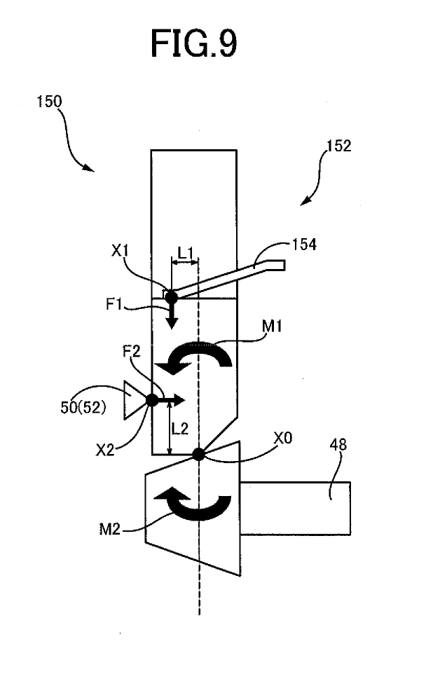

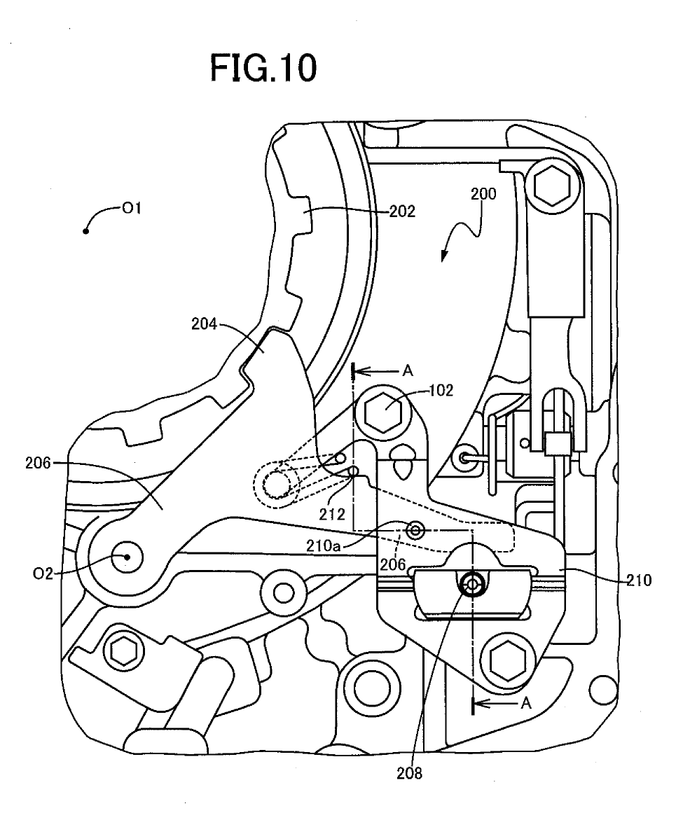

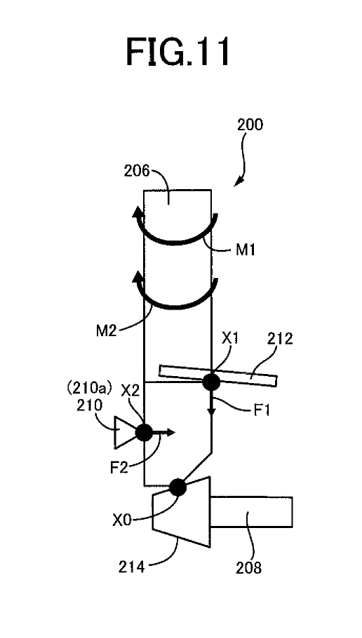

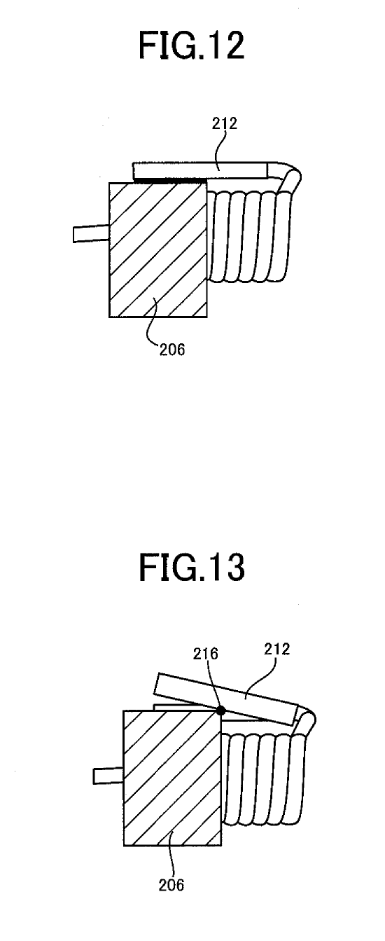

FIG. 9 is a diagram for explaining a parking pole 152 and a coil spring 154 making up a vehicle parking lock device 150 that is another example of the preset invention and corresponds to FIG. 3 of the example. The other members making up the paring lock device 150 are substantially the same as the parking lock device 28 described above and therefore will not be described.

As depicted in FIG. 9, the cutout 68 formed in the parking pole 44 described above is not formed in the parking pole 152. On the other hand, the coil spring 154 is formed such that the contact point X1 between the coil spring 154 and the parking pole 152 is positioned closer to the projection 50 (stopper plate 52) than the contact point X0 between the parking pole 152 and the cam 48 in the plate thickness direction of the parking pole 152 (corresponding to the axial direction of the parking gear 30). Specifically, the coil spring 154 is formed to be away from the cam 48 (upward in FIG. 9) as the coil spring 154 extends from the contact point X1 toward the side apart from the stopper plate 50 in the plate thickness direction of the parking pole 152 (corresponding to the axial direction of the parking gear 30). As described above, the mechanism of setting the contact point X1 closer to the projection 50 than the contact point X0 can be disposed on the coil spring 154, instead of the parking pole 152, to suppress the tilt of the parking pole 152 as is the case with the example. The principle of suppression of the moment M acting on the parking pole 152 is substantially the same as the example and therefore will not be described.

As described above, according to this embodiment, the coil spring 154 is curved such that the contact point X1 between the coil spring 156 and the parking pole 152 is located closer to the stopper plate 52 in the axial direction than the contact point X0 between the parking pole 152 and the cam 48. Consequently, the contact point X1 can be changed to a point closer to the stopper plate 52 in the axial direction than the contact point X0 between the parking pole 152 and the cam 48. Therefore, the configuration described above enables the effect that the tilt of the parking pole 152 can be suppressed as is the case with the example.

Although the examples of the present invention have been descried in detail with reference to the drawings, the present invention is also applied in other forms.

For example, although all the springs are the coil springs 54, 108, and 154 in the examples, the spring is not necessarily limited to a coil spring and, for example, a plate spring may be used as long as a biasing force is generated.

For example, by disposing a projection on the parking pole 44 at the contact point X1 between the parking pole 44 and the coil spring 54, the contact point X1 may be changed to a point closer to the stopper plate 52 in the axial direction than the contact point X0 between the parking pole 44 and the cam 48. In other words, any mechanism changing the contact point X1 closer to the stopper plate 52 in the axial direction than the contact point X0 between the parking pole 44 and the cam 48 is applicable as needed in a range without inconsistency.

The above description is merely an embodiment and the present invention may be implemented in variously modified and improved forms based on the knowledge of those skilled in the art.

### NOMENCLATURE OF ELEMENTS

42: drive wheel 26: drive gear (rotating member) 28,100,150: vehicle parking lock device 30: parking gear 44,102,152: parking pole 45,106: support shaft 46: claw portion 48: cam 50: projection 52: stopper plate 54,108,154: coil spring (spring) 68: cutout 110: spring insertion hole X0: contact point between parking pole and cam X1: contact point of contact between spring and parking pole

1. A vehicle parking lock device stopping rotation of a parking gear formed on a rotating member coupled to drive wheels to stop rotation of the drive wheels, comprising: a parking pole having a claw portion for engagement with the parking gear, the parking pole being allowed to rotate around a support shaft by pushing out a cam movable in an axial direction of the parking gear, the support shaft being in parallel with the axial direction; a stopper plate contacting the parking pole to regulate movement of the parking pole in the axial direction; and a spring contacting the parking pole to bias the parking pole in a direction of release of engagement between the claw portion of the parking pole and the parking gear,
the vehicle parking lock device being configured to dispose a contact point of the contact between the spring and the parking pole closer to the stopper plate in the axial direction than a contact point between the parking pole and the cam.

2. The vehicle parking lock device of claim 1, wherein a cutout for preventing contact between the parking pole and the spring is formed on a side opposite to the stopper plate side in the axial direction of the parking pole.

3. The vehicle parking lock device of claim 1, wherein
the parking pole has a spring insertion hole formed for inserting the spring, wherein the spring is inserted into the spring insertion hole to be in contact with the parking pole, and wherein
a hole diameter of the spring insertion hole is formed larger on the side opposite to the stopper plate side in the axial direction as compared to a diameter on the stopper plate side in the axial direction to prevent the parking pole from contacting the spring.

4. The vehicle parking lock device of claim 1, wherein the spring is formed such that a contact point between the spring and the parking pole is located closer to the stopper plate in the axial direction than a contact point between the parking pole and the cam.
